(19) United States
(12) Patent Application Publication
(10) Pub. No.: US 2022/0044205 A1
(43) Pub. Date: Feb. 10, 2022

(54) SYSTEMS AND METHODS FOR MANAGING INTERVIEW INFORMATION

(71) Applicant: Improving Interviews, LLC, Westerville, OH (US)

(72) Inventors: Joshua Demidovich, Westerville, OH (US); Troy Gibson, Westerville, OH (US); Kenneth Green, Westerville, OH (US)

(21) Appl. No.: 17/396,343

(22) Filed: Aug. 6, 2021

Related U.S. Application Data
(60) Provisional application No. 63/061,974, filed on Aug. 6, 2020.

(51) Int. Cl. G06Q 10/10

(52) U.S. Cl. CPC G06Q 10/1053

(57) ABSTRACT

Systems and methods for organizing, managing, and generating information and resources for use in connection with interviews. User configurable systems track upcoming interviews, generate interview packets according to user selections that are customized according to the intended recipient. A central server directs the creation of resources and notifications for pre- and post-interview activities. Questionnaires are generated for a variety of users according to a predetermined schedule and submitted answers are transmitted to one or more users according to predefined parameters.

### CROSS-REFERENCE TO RELATED APPLICATIONS

This application claims priority to U.S. Provisional Application No. 63/061,974, filed Aug. 6, 2020. The contents of U.S. Provisional Application No. 63/061,974 are hereby incorporated by reference as if fully recited herein.

### TECHNICAL FIELD

Exemplary embodiments relate generally to systems and methods for managing interview information. In particular, exemplary embodiments relate to computerized systems and methods for obtaining, tracking, querying, and reporting interview information for a variety of users and generating resources related to the interview process.

### BACKGROUND OF THE INVENTION

Many businesses rely on staffing companies and/or recruiters in order to fill their workforce. This is especially the case for businesses that employ high numbers of jobs in manufacturing, packaging, logistics, and tech fields, among others. The staffing industry must perform high numbers of candidate interviews on a daily and weekly basis in order to keep up with business client demands for qualified workers. Currently the staffing industry lacks both the ability and/or consistency to automate the interview preparation process for job seekers with professionally recommended strategies. Similar issues exist for businesses who perform internal hiring as well, whether through internal recruiting teams or managers hiring directly. Conventional applicant tracking systems (“ATS”) and human resources information systems (“HRIS”) do not provide any assistance with preparing for, or conducting, interviews. That is, there is no solution that provides tools for increasing the productivity and quality of the interview itself, including preparing both the job seeker and the interviewer so that they can engage in a more meaningful interview. Conventional systems also lack an automated way to gather feedback from interview participants. Conventionally, the interview experience itself has been ignored, which stymies the ability of an interviewer to build and improve their interviewing skills, reduces the success of a staffing company and recruiter, results in hires that may not be good fits for a position, and otherwise result in an undesirable interview experience for all involved. Corporate culture and image may be negatively impacted by interviews involving participants that are not properly prepared, and both staffing companies and employers may suffer the costs of having empty positions.

Consistency is also an issue as there are multiple conventional ATS and HRIS systems and tool sets, and users may interact with more than one. This can create confusion and disorganization when utilizing different platforms. Conventionally, there is no solution that can plug into multiple ATS and/or HRIS tool sets to obtain all the information and data necessary to engage in proper interview management.

### SUMMARY OF THE INVENTION

Described herein are exemplary systems and methods for organizing and generating information and resources for use in connection with interviews. Exemplary systems and methods include user-configurable systems configured to obtain information from one or more outside ATS or HRIS systems about one or more interview events, creating interview summaries and reports using such information, selecting questions and other information determined to be relevant to an interview event, generating resources such as an interview packet to facilitate the interview process, transmitting an interview packet to a user (including an interviewer and/or interviewee) querying one or more users for feedback post-interview according to a predetermined schedule, and managing received feedback responses so that future interviews can benefit from the feedback.

In one embodiment, the method for managing interview information includes: identifying an interview event involving an applicant and at least one interviewer; identifying a remote system that contains information relevant to the interview event stored on a non-transitory computer-readable storage medium; connecting a central server to the remote system over a network, where the central server comprises a non-transitory computer-readable storage medium and a server-based processor; loading a template onto the computer-readable storage medium of the central server, the template comprising at least one field that is populatable with information related to an interview event; receiving, on the central server, the information on the remote system; storing the information on the computer-readable storage medium of the central server; populating a field of the template with the information to create an interview packet; and transmitting the interview packet to a user device.

In another embodiment, the system for managing interview information includes a central server comprising a non-transitory computer-readable storage medium and a server-based processor. The system also includes a template stored on the computer-readable storage medium that includes at least one field that is populatable with information related to an interview event. The system also includes program instructions stored on the non-transitory computer-readable storage medium and executable by the server-based processor that, when executed, perform operations that include: connecting, over a network, the central server to a remote system that has stored information relating to an interview event; receiving, on the central server, the information on the remote system; storing the information on the computer-readable storage medium of the central server; and populating a field of the template with the information to create an interview packet. The method also includes a user interface configured to receive user input directing the central sever to initiate the execution of the program instructions.

In yet another embodiment, the method for managing interview information includes: identifying an interview event involving an applicant and at least one interviewer; receiving, on a central server, information about the interview from one or more interview information sources, the central server includes a non-transitory computer-readable storage medium and a server-based processor; storing the information on the computer-readable storage medium of the central server; loading a template onto the computer-readable storage medium of the central server, the template includes at least one field that is populatable with information related to an interview event; populating a field of the template with the information to create an interview packet; and transmitting the interview packet to a user device.

In still another embodiment, the method includes identifying an interview event involving an applicant and at least one interviewer; identifying an applicant tracking system that contains information relevant to the interview event stored on a non-transitory computer-readable storage medium; connecting a central server to the applicant tracking over a network, the central server comprising a non-transitory computer-readable storage medium and a server-based processor; data mapping the locations of information on the applicant tracking system; loading a template onto the computer-readable storage medium of the central server, the template comprising at least one field that is populatable with information related to an interview event; receiving, on the central server, the information on the applicant tracking system; storing the information on the computer-readable storage medium of the central server; populating a field of the template with the information to create an interview packet; and transmitting the interview packet to a user device.

### DRAWINGS

FIG. 1 is a flow diagram depicting an exemplary embodiment of the system of the present disclosure, showing the transmission of information to a central server;

FIG. 2 is a flow diagram depicting the system of FIG. 1 showing the transmission of an interview packet, a questionnaire, and feedback data;

FIGS. 3A-3D is an exemplary form for gathering information from users;

FIG. 4 is an exemplary Recruiter Dashboard screen according to an exemplary embodiment;

FIG. 5 is an exemplary Interview Details screen according to an exemplary embodiment;

FIG. 6 is an exemplary Interviewers screen according to an exemplary embodiment;

FIG. 7 is an exemplary Interviewer Details screen according to an exemplary embodiment;

FIG. 8 is an exemplary Interview Details screen according to an exemplary embodiment;

FIG. 9 is an exemplary View Interview Packet window according to an exemplary embodiment;

FIG. 10A-10E is an exemplary interview packet according to an exemplary embodiment;

FIG. 11 is an exemplary My Interviews screen according to an exemplary embodiment;

FIG. 12 is a data flow diagram depicting an exemplary embodiment of the system of the present disclosure;

FIG. 13 is a data flow diagram depicting a first exemplary embodiment of the method of the present disclosure.

FIG. 14 is a data flow diagram depicting a second exemplary embodiment of the method of the present disclosure.

### DETAILED DESCRIPTION

In an exemplary embodiment, a system for generating interview packets which may be used to assist in the preparation and/or conducting of an interview (also referred to as an “interview event”) is provided. The interview packets may include, for example, but not be limited to, useful information about the employment position and employer, the scheduling and format of the interview, recommended questions, and interview tips. It is contemplated that such interview packets maybe useful for both the applicant and the interviewer(s).

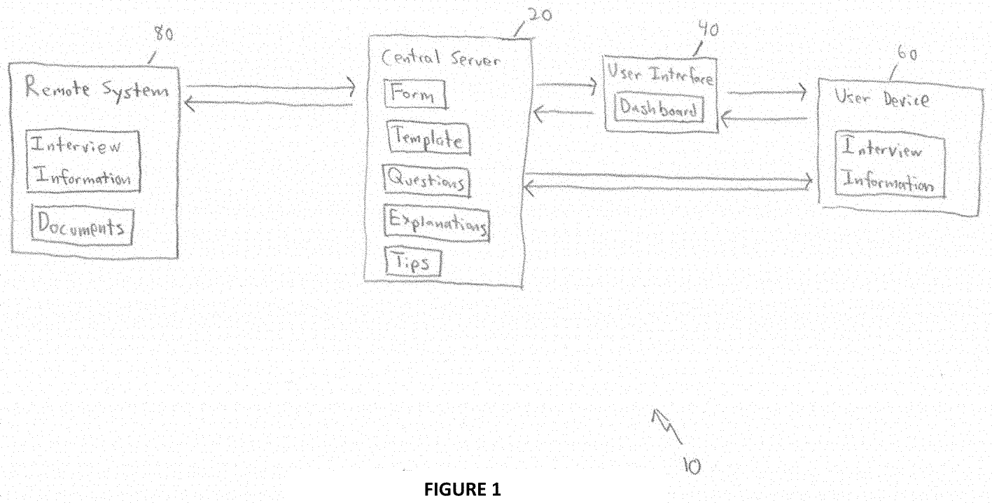

Referring to FIG. 1, the system 10 includes a central server 20 which may be any configuration of hardware and software that can perform the functions discussed in this disclosure (described in greater detail as follows). The central server 20 may also comprise a variety of decentralized and/or distributed computing systems. Nothing herein is intended to limit the central server 20 to any one single embodiment of hardware and/or software. In a preferred embodiment, the central server 20 includes a non-transitory computer-readable storage medium and a server-based processor configured to execute program instructions stored on the computer-readable storage medium, with the program instructions enabling the functionalities of the central server 20 discussed herein.

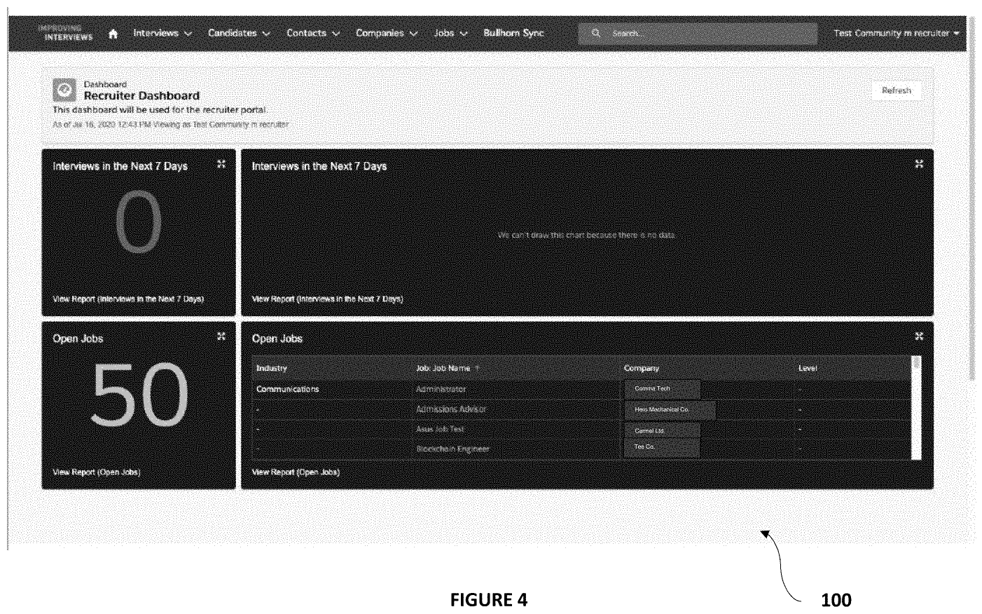

A user may direct the central server 20 to perform the functions discussed in this disclosure by entering user input (i.e., selections and commands) on a user interface 40. The user may be, for example, a recruiter, a staffing agency, an interviewer, an employer, and/or an applicant. The user interface 40 may be a software program capable of receiving user input and directing the central server 20 to execute program instructions. In one embodiment, the user interface 40 may be provided on the central server 20 and accessed through a user device 60 (e.g., smartphone, tablet, personal computer, etc.) (either through a wired connection or over a wireless network). In another embodiment, the user interface 40 may be provided on a different server that is operatively connected to the central server 20, which a user may access through a user device 60. In yet another embodiment, the user interface 40 may be provided in the form of an online dashboard hosted on either the central server 20 or a different server that a user may access through a user device 60 (see FIGS. 4-9 and FIG. 11). It is contemplated that some users may have access to the online dashboard whereas other are merely recipients of information transmitted by the system.

In an exemplary embodiment, the system 10 can create and store user profiles, and provide different levels of access and administrative abilities to different users. For example, some users may have the ability to access different accounts and make edits to a variety of accounts, while other users may only have the ability to edit information in their own account. One of ordinary skill in the art will recognize that the system 10 could allow for a variety of user roles, permissions, and functionalities depending on the particular application. Usernames and passwords, and other forms of authentication, may also be utilized to keep information secure.

In an exemplary embodiment, the system 10 may enable users to register interviews with the system 10, which recognizes each interview as a separate “interview event.” The interview event may be considered “owned” by the user who created it (e.g., a recruiter). Creation of interview events can be performed manually by the user or automatically upon receipt, by the central server 20, of information from a remote system 80. As used herein, the term “remote system′” refers to an outside computing system, which can include any suitable configuration of hardware and software, that has stored information about an employment position, an interview, and/or the people conducting or otherwise affiliated with an interview (e.g., the applicant, interviewer, employer, and/or staffing agency).

One type of remote system 80 that the central server 20 may receive information from is an applicant tracking system (“ATS”). An ATS may comprise one or more servers associated with one or more databases containing a variety of information stored in a variety of formats. In an exemplary embodiment, the ATS may be any variety of commercially available system, including but not limited to Bullhorn, available from Bullhorn Inc. of Boston, Mass., and Pinpoint. In an exemplary embodiment, the central server 20 receives information from a plurality of ATS systems about a plurality of interview events.

The central server 20 may be configured to connect to, and receive information from, one or more ATS systems over a network (either wired or wireless). Connecting the central server 20 to an ATS may generally require requesting back-end permissions from a server administer or anyone with the authority to grant such permissions. Upon grant of such permissions, the central server 20 may then connect to the ATS though one or more application programming interfaces (APIs). Doing so grants the system 10 access to shared files and/or documents stored in the ATS. Data mapping may also be required to locate information, or sets of information, on the ATS relevant to an applicant or an interview event.

Information on the ATS that may be relevant to the interview packet may include information about the applicant and/or information about the interview, such as, but not limited to, personally-identifying information about a job candidate, candidate qualifications and experience, information about the employment position, company/employer information, interviewer information, and logistical details about the interview including where and when it is to be conducted (date/time, including start and/or end times). Documents on the ATS that may be relevant to the interview packet may include documents associated with the applicant such as, but not limited to, resumes, cover letters, letters of recommendation, and the like. Further, the ATS may also include branding information such as a company logo associated with the interviewer's organization.

Another type of remote system 80 that the central server 20 may receive information from is a human resource information system (“HRIS”). An HRIS may comprise one or more servers associated with one or more databases containing a variety of information stored in a variety of formats. In an exemplary embodiment, the HRIS may be any variety of commercially available systems, including but not limited to Namely, available from Namely Inc of New York, N.Y.; Workday, available from Workday Inc of Pleasanton, Calif.; and Optimum HRIS, available from Optimum Solutions Inc of Nashville, Tenn. In an exemplary embodiment, the central server 20 receives information from a plurality of HRIS systems about a plurality of interview events.

The central server 20 may connect to, and receive information and/or documents from, an HRIS over a network through an API after receiving back-end permissions. Data mapping may also be required to locate information, or sets of information, on the HRIS relevant to an applicant or an interview event.

Information contained on an HRIS that may be relevant to the interview packet can include, but is not limited to, personally identifying information about an interviewer, company/employer information, the duties and responsibilities associated with the employment position, compensation information, logistical details about the interview including where and when the interview is to be conducted (date/time). The HRIS may also include branding information such as a company logo associated with the interviewer's organization.

It is contemplated that the central server 20 may receive information from several ATS systems, or several HRIS systems, or several of both. One of ordinary skill in the art will further recognize that a variety of other commercially-available systems may also be used to input interview event information, without departing from the scope of the invention.

Those skilled in the art will appreciate that various remote systems may be owned/operated by wide range of organizations, each of which may have their own way of storing, organizing, and presenting information that is relevant to an interview event. One aspect of the system 10 is to improve upon this by providing a way of unifying all this information into a consistent form—the interview packet—and making this information accessible to those who need it most, the applicant and the interviewer.

The information and/or documents from an ATS, HRIS, and/or other remote systems 80 may be transmitted to the central server 20 according to an automated synchronization set according to a predetermined time schedule or event schedule, or through a button trigger synchronization that is initiated by one or more users.

Information and/or documents transmitted to the server from an ATS, HRIS, or other remote systems 80 may be stored in one or more storage mediums (i.e., non-transitory computer-readable storage mediums) associated with, or otherwise connected to, the central server 20. One of ordinary skill in the art will recognize that storage of received information can be achieved in a wide variety of ways without departing from the scope of the invention. Furthermore, it is contemplated that any amount of information generated or stored by the system 10 may be transmitted to one or more outside systems for backup.

The central server 20 may enable a user to edit information received from remote systems 80. It is contemplated that this functionality may be desired, or even necessary, if the information received from the remote systems 80 is incorrect or formatted in a less than optimal way.

In addition to information from remote systems 80, it is contemplated that the central server 20 may also receive and store information that a user inputs directly through the user interface 40. This direct-from-user interview information may be used to create an interview packet either in addition to, or as an alternative for, information gathered from a remote system. The information collected in this way may be used to supplement the information collected from a remote system, or to remedy any deficiencies in the information already received (i.e., missing information). The system 10 may also affirmatively seek information from users by transmitting, to a user device 60 (e.g., phone, tablet, or PC), or to a user interface 40 accessible by a user device 60, a form containing questions relevant to the interview packet. This direct-from-user information may be stored on the central server 20 or on a computer-readable storage medium located elsewhere but operatively connected to the central server 20.

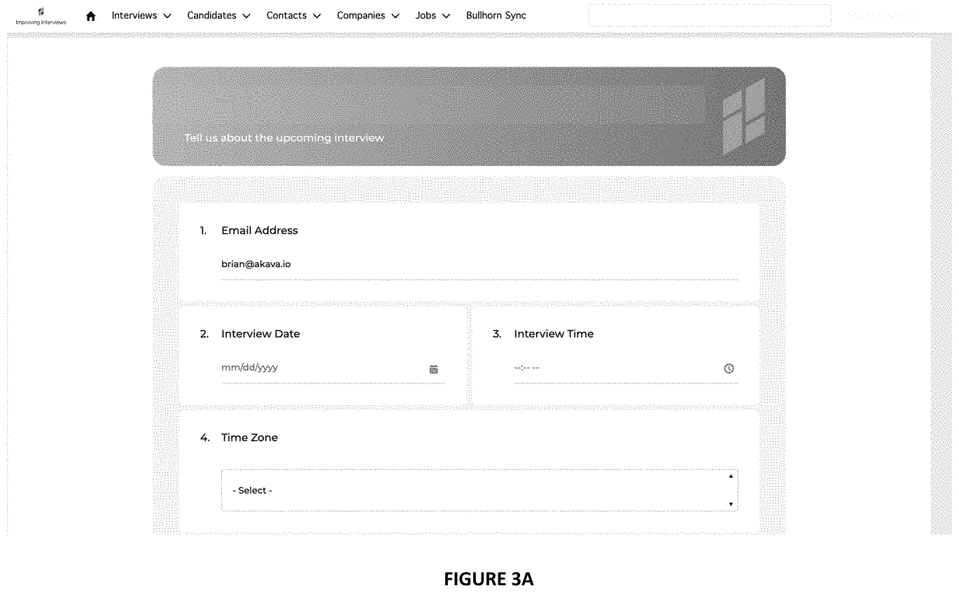

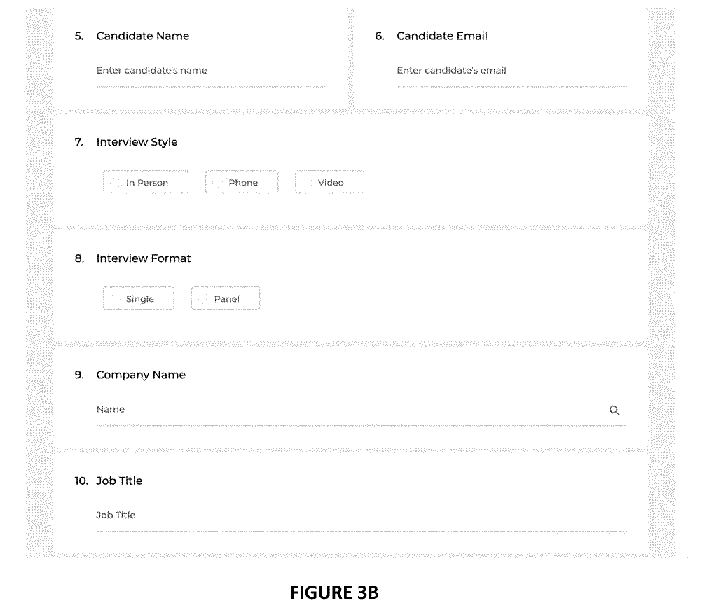

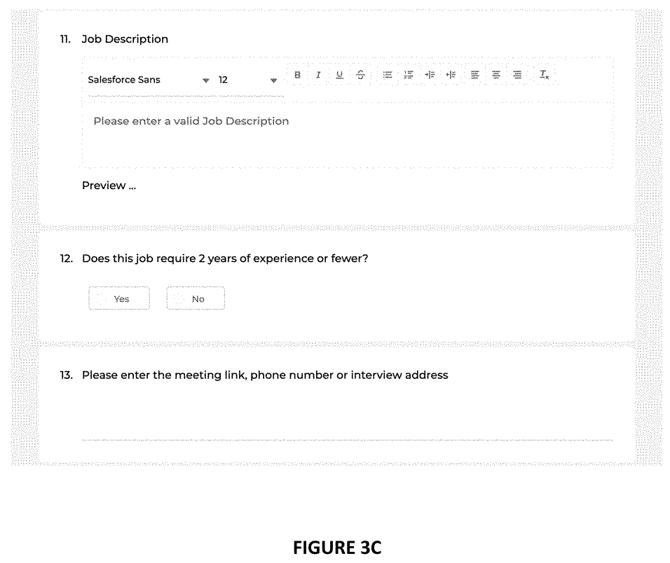

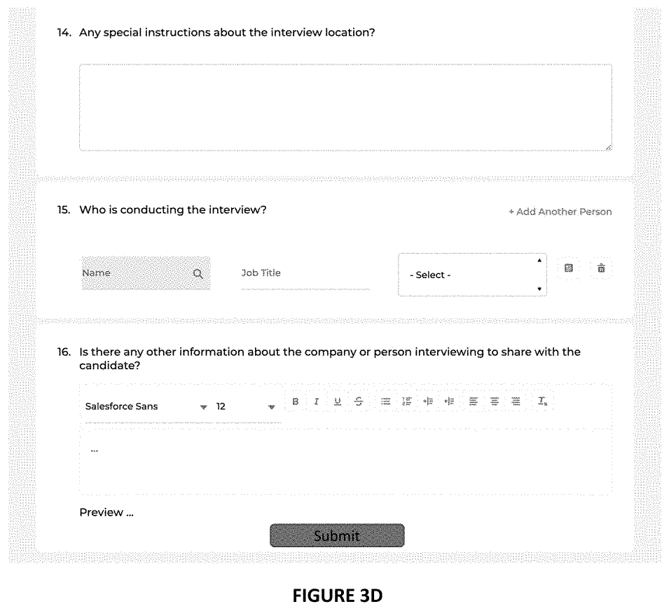

Referring to FIGS. 3A-3D, the present disclosure provides an exemplary embodiment of a form that the system 10 may transmit to a user for gathering information about an interview. As shown, the form features a number of fields for a user to fill out including: (1) email address, (2) interview date, (3) interview time, (4) time zone, (5) candidate name (i.e., applicant), (6) candidate email, (7) interview style, (8) interview format, (9) company name (i.e., employer), (10) job title, (11) job description, (12) the question “Does this job require 2 years of experience or fewer?”, (13) the suggestion “Please enter the meeting link, phone number or interview address”, (14) “the question “Any special instructions about the interview location?”, (15) the question “Who is conducting the interview?”, and (16) the question “Is there any other information about the company or person interviewing to share with the candidate?” This embodiment of the form is designed to be displayed on the dashboard 100 shown in FIGS. 4-9 and FIG. 11. However, it is also contemplated that this form may also be transmitted directly to a user device 60. Information that is gathered in this way may be transmitted to, and saved on, the central server 20 or on a different sever accessible by the central server 20. As shown, a “submit” button is also provided to initiate the transmission of information.

In an exemplary embodiment, the system 10 may also scan (i.e., scrape) documents and websites (e.g., the company website, the website of a staffing agency, LinkedIn profiles, etc.) to identify and transfer to the central server 20 information that may be relevant to the interview packet based on the presence of key words. It is contemplated that this information may be used to, among other things, provide background information about the company, discover recent developments, and/or to find topics of interest that the applicant and the interviewer can talk about during the course of an interview. Those skilled in the art will appreciate that there are several systems, programs, and the like that enable this type of functionality and the use of which will not depart from the scope of the present invention.

In addition to scanning or scraping information for use in an interview packet, it is also contemplated that the system may generate and transmit alerts to one or more users based on the information gathered. For example, the system may identify a press release from the company and transmit it, in the form of an alert, to a user. In another example, the system may identify a LinkedIn profile update from an interviewer and transmit information about the update to an applicant so that the applicant may discuss it with the interviewer during the interview (e.g., for the purposes of finding common interests). In an exemplary embodiment, the system may identify an interview schedule for an interview event in which there are multiple applicants and alert one or more of those applicants if a scheduled interview gets canceled. Those skilled in the art will appreciate that there may be other useful applications of this scan-and-alert feature, the use of which will not depart from the scope of the present disclosure

The system 10 may utilize the information received from one or more remote systems 80 as well as the information received directly from users to create an interview packet. The interview packet is a collection of information related to the interview event. It may be created for the applicant and/or the interviewer, and may include information about the job position, interview logistics, the job description and job responsibilities, and any special instructions. The interview packet may also include information about the role of the interviewer and the type of interview. For example, an interviewer “role” could be a peer or HR (human resources representative). An interview type could be in person, over the telephone, or as part of a video chat.

The system 10 includes program instructions that, when executed, direct the system to create an interview packet. This process may be initiated based on a predetermined time schedule or event schedule, or through a button trigger synchronization that is initiated by one or more users.

To create the interview packet, templates may be preloaded onto the central server 20 that contains fields that can be populated by the information received. For example, a template may include fields such as, but not limited to, the identity of the applicant, the identity of an interviewer, the identity of the employer, the time and location of the interview, the level of employment position being applied for (e.g., entry or senior level), the format of the interview (e.g., in-person or virtual), and the number of interviewers that will be conducting the interview (e.g., one-on-one or before a panel). In preferred embodiments, the template may also be user-configurable such that different fields may be included over others or may be arranged in a different way.

The system 10 may select pieces of information received from one or more remote systems 80, or information that was directly received from a user, to populate the fields of a preloaded template. Selection may be performed either manually, or through use of an algorithm that recognizes the type of information received.

The central server 20 may further include a pool of suggested questions that an applicant can ask interviewer, or that an interviewer can ask an applicant. In preferred embodiments, the system 10 may include one or more of these questions into the interview packet as a way of encouraging a more engaging and fruitful interview.

The central server 20 may further include a pool of explanations to the suggested questions. The system 10 may include one or more of these explanations in the interview packet, alongside the associated question, as a way of providing context into why the question should be asked. It is contemplated that these explanations may allow the interviewer to understand the reasoning behind a particular question which better enables the interviewer to be prepared for the particular interview event, as well as any interviews they might conduct in the future. Providing an interview packet to an interviewer may therefore be useful in a variety of hiring settings including corporate hiring settings. Accordingly, in a variety of hiring settings the system 10 may be used to generate interview packets for both the interviewer and interviewee.

As an example, a suggested question may be “If I get this job, who will I be working with on a daily basis?” The explanation for this question may be “This question demonstrates that you are thinking ahead and that you have an interest in the people around you.”

The central server 20 may further include a pool of tips for the user that may, among other things, help the user better present him/her-self to the interviewer or to better vocalize their value. For example, a generally helpful tip may include information about how to achieve appropriate lighting for a video interview. Another generally helpful tip may include information about how to articulate certain skills.

In exemplary embodiments, questions, explanations, and tips may be selected (either manually or by way of an algorithm) from their respective pools based on the substance of populated fields (i.e., “interview factors”). This functionality may be useful since some questions, explanations, and/or tips may be more appropriate for some applicants or interviewers than they would be for others. Some relevant interview factors can include, for example, the level of the employment position (e.g., entry level, senior level, etc.), whether the interview is in-person or a phone/video interview, and whether the interview is one-on-one or before a panel. By way of this functionality, the resulting interview packet may be customized for particular applicants and interviewers, thereby maximizing the effectiveness of interview preparation.

In exemplary embodiments, questions, explanations, and tips may be organized into various “buckets” in their respective pools, wherein each bucket represents an interview factor or a combination of interview factors. For example, the system 10 may include a bucket of questions for entry level positions, or another bucket for video interviews. In another example, the system 10 may include a bucket for one-on-one interviews conducted over the phone. Those skilled in the art will appreciate that buckets may be made for ostensibly any interview factor, or combination of interview factors, without departing from the scope of the present disclosure.

Selection of questions, explanations, and tips from one or more of these buckets may be performed randomly or based on predetermined value. If based on a predetermined value, the questions, explanations, and/or tips may be rated based on their overall usefulness. Some questions, explanations, and/or tips, even if belonging to the same bucket, may be generally more useful/applicable than others.

The number of questions, explanations, and tips selected for any particular interview packet does not need to be limiting. In fact, the number can vary depending on, for example, the amount of preparation needed for a particular interview, or the amount of experience a particular applicant has participating in interviews. In a preferred embodiment, the system 10 may randomly select three questions, explanations, and/or tips from a bucket to include in an interview packet based on the interview factors inputted into a template.

In addition to questions and question explanations, the interview packet may also include any resume, cover letters, letters of recommendation, or other materials that have been supplied by a job candidate.

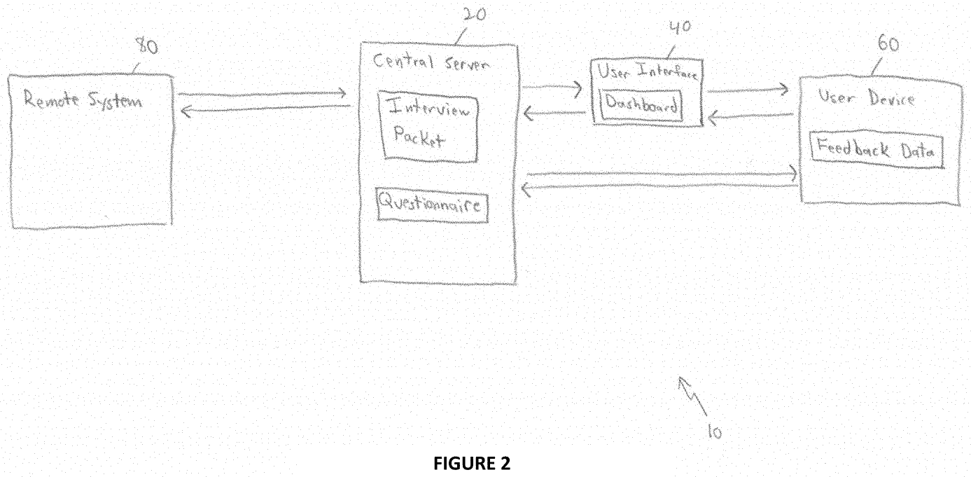

Referring to FIG. 2, once the interview packet is generated, it can be emailed to one or more email addresses associated with the interview event or displayed on the user interface. If transmitted through email, the email addresses may be associated with the owner of the interview event and/or the interviewer, if the interviewer is not the same person as the owner. In situations where the interviewee is receiving interview packet an email address may be for the interviewee (job candidate). The central server 20 may generate notifications to be received by a user device 60 indicating that the interview packet has been generated and/or providing a copy. For example, an SMS or MMS text message may be initiated by the central server 20 and transmitted over a network to one or more user devices 80. The interview packet may be transmitted to various user devices 80 in a variety of ways. The interview packet may also be generated in a form compatible to be uploaded into a variety of outside platforms.

It is also contemplated that the process of sending an email containing the interview packet may be automated. For example, the system may automatically create and send the email following the creation of the interview packet. The system may identify one or more of the parties listed on the interview packet (e.g., the applicant and/or the interviewer), identify the contact information of the one or more parties from a database (e.g., the central server, a remote system, etc.), and then transmit the email containing the interview packet using the contact information. Alternatively, it is also contemplated that a user may preemptively input the email address of a desired recipient and have the system automatically send the mail to that email address following the completion of an interview packet for that recipient.

In an exemplary embodiment, the system may provide for integration with a scheduling or calendar program. In this way, the recipient of an email containing an interview packet may easily add/register the interview event to a scheduling or calendar program as a way of keeping track of the interview. For example, it is contemplated that the system may provide integration with the scheduling/calendar feature of Microsoft Outlook, available from Microsoft Corporation of Redmond Wash.

It is further contemplated that the system may schedule a different event by via the email containing the interview packet. For example, a different event that may be scheduled may be a pre-interview “prep call” in which the recipient is scheduled to speak/confer with an interview specialist as a way of practicing or otherwise preparing for the interview. It is contemplated that this pre-interview “prep call” may also be used to explain the details and features of the interview packet, thereby improving interview preparation efforts.

The interview packet may also include the branding that was supplied by the ATS or entered by the user, providing a professional appearance.

In an exemplary embodiment, the central server 20 generates one or more questionnaires or feedback surveys that is transmitted to a user (which may be an interviewer or interviewee) after a predetermined time has expired after the scheduled end of the interview. For example, if an interview according to a particular phone interview event was scheduled to end at 3:00 pm, the central server 20 may transmit a questionnaire to the relevant user(s) at 3:15 pm. In another scenario involving an in-person interview it may be an hour later. Whether to send, and when to send a questionnaire may be determined by the central server 20 according to inputs selected by the user on the user interface 40. For example, a user may require that the survey be sent in a matter of minutes, hours, or even days after an interview. The system 10 may generate a questionnaire to receive feedback from the interviewer, the interviewee, or both depending on the hiring setting and user selections entered into the system 10.

In an exemplary embodiment, users can freely edit each interview event to dictate properties of the questionnaire. Questions previously entered by a user or otherwise stored or received by the system 10 may be presented to a user as options for selection. The user may not only have the ability to select presented questions, but may also be able to enter any new question or questions of their choosing.

The questionnaire may ask a variety of one or more questions. For example, a question could be “Were any questions asked that did not seem relevant to the job description?” or “Did you feel any implicit bias from the interviewer?” or “Were any questions asked that were not covered in the pre-screen?” or “Did the Interviewee Seem Prepared?” The user may also be presented with the ability to enter any other feedback or thoughts they might have about the interview, the position interviewed for, the employer, or the interviewer.

A questionnaire may be sent via email to an email address associated with the interviewer or interviewee, or via text to a phone number associated with the interviewer or interviewee. The questionnaire may be automated with text fields and other selections that the recipient can use to answer. Answers to the questionnaire may be transmitted back to the system 10 and stored. Upon receipt of any answers the central server 20 may issue a notification to the owner to inform them that the answers are ready for review. In an exemplary embodiment the answers are automatically transmitted to via email or text to one or more user devices 60 associated with the owner or anyone else the owner has identified as having permission to view the questionnaire answers. In an exemplary embodiment the interviewer or interviewee is also sent a copy of their answers to the questionnaire in an email or via other means.

In an exemplary embodiment, questions presented on the questionnaire are identified by the system 10 as pertaining to one or more categories. The system 10 may be able to track the category or categories associated with each question, and attribute the same category or categories to any answer provided to each question. Upon receipt of the answers, the system 10 may send questions and answers to users according to category. In an exemplary embodiment, the system 10 may send a first subset of questions and answers to a first user and a second subset of questions and answers to a second user. Accordingly, the system 10 may split the response to the questionnaire according to different users and/or their roles. For example, any questions pertaining to company culture may go to a user associated with the human resources department, and any questions pertaining to the questions asked in the interview may go to the interviewer. The system 10 is able to provide different users with the most relevant feedback to their role.

A user may select answers that they want stored in an ATS or HRIS system. Selected answers may be transmitted by the central server 20 to the ATS or HRIS system for storage pursuant to routine and automated synchronization, or button trigger synchronization.

As those skilled in the art will appreciate, the result of transmitting and receiving questionnaires is an accumulation of feedback data that may be valuable or otherwise useful for future employment, interviewing, and/or recruiting efforts. This feedback data may be, but need not, be stored on the central sever 20. It is contemplated that this feedback data may include wide ranging demographic information that could inform interested parties (such as corporations, research organizations, and the like) about the type of applicants that a particular company is attracting, or the type of applicants a staffing company is sending. Further, by gathering and localizing this feedback data, the system well situated (and in exemplary embodiments, capable) of organizing and presenting this data in a consistent and comprehensive form. It is contemplated that the system may also redact personal information so as to protect the privacy of the applicants, interviewers, and the like, that the system is gathering feedback data from. In exemplary embodiments, the system may also be configured to report out this data to persons of interest, preferably in a consistent report format, or present this feedback data on the dashboard for certain users.

The system may also include program instructions that enable algorithmic/machine-learning capabilities as a way of analyzing feedback data. In an exemplary embodiment, these capabilities may be used to determine, based on one or more predetermined factors present in the feedback data (for example, in the form of a particular response or combination of responses in a questionnaire), the likelihood that a particular applicant gets hired. Here, it is contemplated that feedback data from both the applicant and the interviewer may be useful for making this determination. Thus, the system may send questionnaires to both. However, it is also contemplated that this determination may be made with only feedback from one or the other. The system may also report out this determination to a user by presenting it on the dashboard, or by transmitting it directly to a user device.

In an exemplary embodiment, the user interface of the system may be an online dashboard that the system generates for a user. This dashboard may, but need not, be hosted on the central server. Referring to FIG. 4, an exemplary embodiment of a dashboard 100 is shown. This dashboard 100 may be presented for use by a recruiter or other user who conducts interviews with job applicants. As can be seen, several modules may be presented on the main dashboard screen. The number of upcoming interviews may be displayed. The number of upcoming interviews in the next seven days, or any other number of upcoming days or weeks, may be presented. The number of open jobs is also displayed. Open jobs may refer to the jobs that have not been filled, and related to one or more interview events. As shown in the exemplary embodiment, open jobs may include those for a variety of positions with a variety of employers. The dashboard 100 may provide active links for each “job name” and “company” listed on the dashboard 100, allowing a user to select the link to obtain more information. A refresh button on the dashboard 100 may allow a user to obtain up to date information. The dashboard 100 may also refresh automatically in order to present a real-time view of relevant information.

The dashboard 100 may be customizable and allow a user to configure what information they would like displayed on the dashboard 100. For example, a user may set the dashboard 100 view to report the number of interviews scheduled over a time period of the user's choosing (e.g., 10 days or 3 weeks). Or the user may set the dashboard 100 to prominently identify interviews pertaining to a certain employer. The dashboard 100 could also display to a user their success rate over a preset historical time frame in getting job candidates hired, which could be particularly helpful if the user is at a staffing company. One of ordinary skill in the art will recognize that the dashboard 100 could be user configurable in a variety of ways and be designed to display a wide variety of information at a user's choosing.

As shown in FIG. 4, at the top of the screen may be several menu options for viewing a variety of information, including links for “Interviews,” “Candidates,” “Contacts,” “Companies,” “Jobs”, and Sync. A user may also be able to conduct searches by entering word or works into a search field.

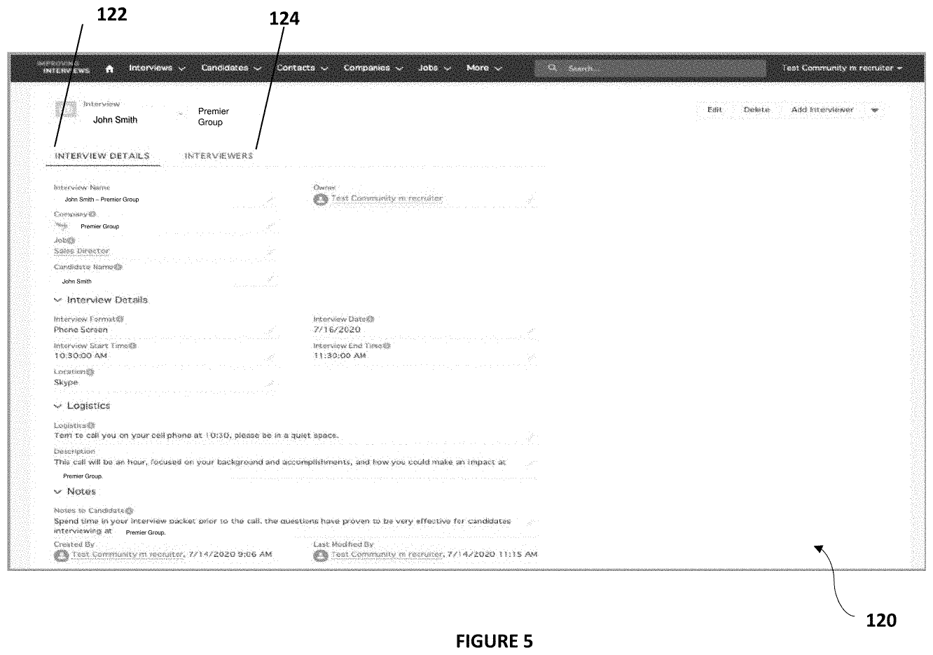

Referring to FIG. 5, an exemplary embodiment of an Interviews screen 120 is provided. The Interviews screen 120 may provide the user with a variety of information pertaining to both interview events and interviewers, as well as the ability to edit information. In FIG. 2, an “Interview Details” tab 122 is selected. The Interview Details tab 122 displays name of the job candidate, the job title, and company/employer is displayed, along with interview details including, but not limited to, the format of the interview (“phone screen”), the location (“Skype”), the date of the interview, and the start/end times of the interview. Logistical information and notes to the candidate are also included. As can be seen, various types of information can be shared with a candidate, including tips for succeeding in the interview, and insight on the employer. Interview details also includes information regarding who created the interview event and who last modified the interview event. The owner is also indicated, which may be the same as who created the interview event.

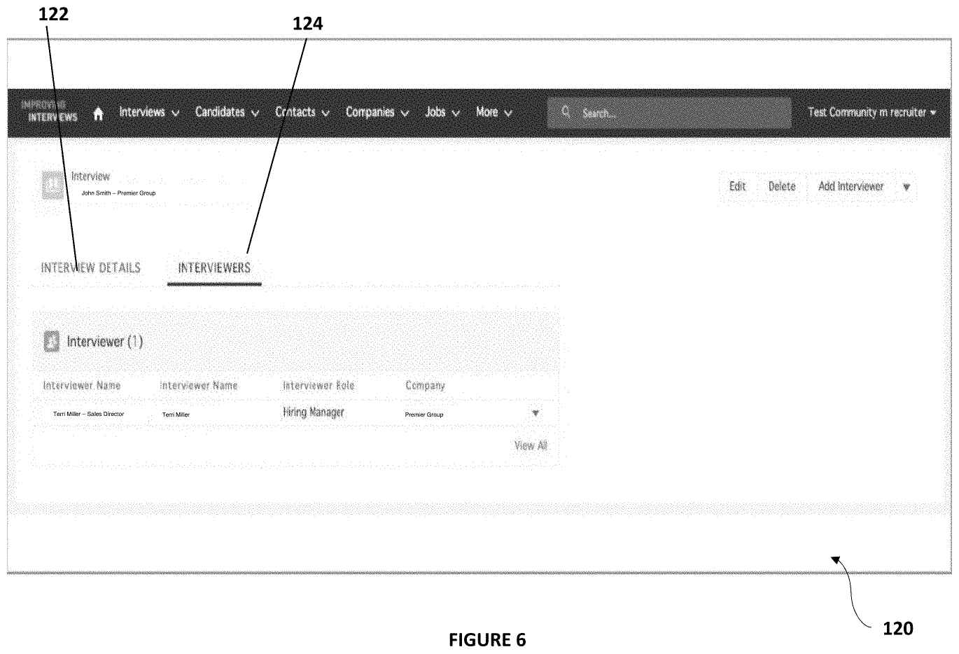

Referring to FIG. 6, the “Interviewers” tab 124 of the interviews screen 120 has been selected. This tab 124 displays all of the interviewers associated with a particular interview event, as well as their role and their company. In the exemplary tab, a single interviewer is associated with the interview event. However, depending on the interview event there could be multiple interviewers involved with differing roles and even different company affiliations. For example, an interview might include both a peer interviewer and a Hiring Manager interviewer. Depending on the customized settings of a user, the Interviewers tab 124 may either show everyone associated with an interview or just a main point person (who may or may not be the owner). The tab 124 allows a user to edit information, delete interviewers, or add new interviewers. Information about a particular interviewer can be seen by clicking on an active link.

Information presented on the Interviewers tab 124 may be populated with a selection of information that has been received from an ATS, HRIS or another outside platform. When information pertaining to an interview event is imported from such an outside system, the “Interviewer” may be automatically established as a contact in the system. The “Owner” associated with the interview event may also be established as a contact in the system, if not the same as the Interviewer. Additional information such as the role may also be pre-populated. However, a user may always have the ability to populate by manual entry any fields that are not pre-populated, and always has the ability to edit any information. In an exemplary embodiment the system is able to pull information from online sources such as LinkedIn, a product available from LinkedIn Corp. of Sunnyvale, Calif., or the internet.

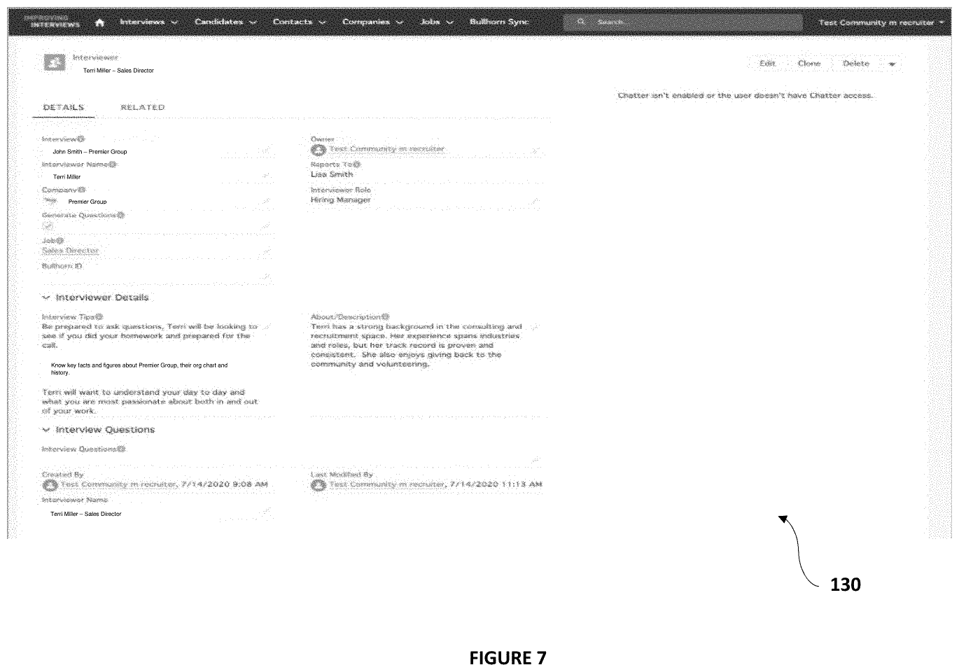

Referring to FIG. 7, an Interviewer screen 130 is provided. This screen 130 allows a user to view a variety of information pertaining to a particular interviewer (e.g., an interviewer profile) that has been recorded by the system. Information may include general information such as name, company, etc. It may also include details about the interviewer's style of interviewing, any candidate traits that the interviewer has been known to focus on, frequently asked questions, and any other types of information that might help a job candidate navigate an interview with the particular interviewer. Some or all of this information may be supplied by an ATS, HRIS, or another outside platform.

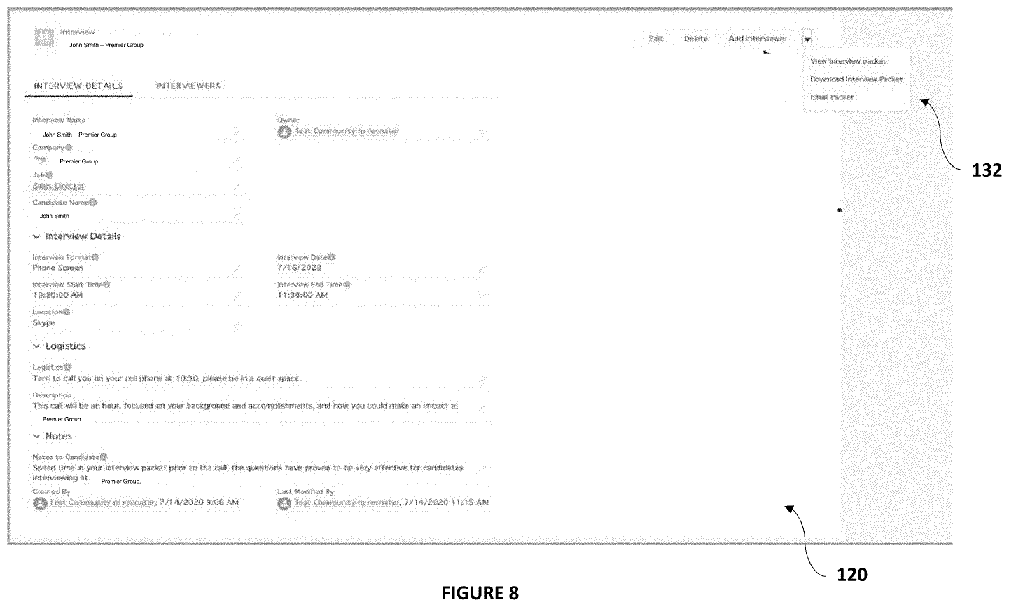

A user, which may be the Owner of a particular interview event, may review all relevant information regarding the interview, interviewer, and otherwise confirm that all materials and information needed has been provided. The user may then instruct the system to generate an interview packet. Referring to FIG. 8, a variety of options related to the generation and transmission of an interview packet can be selected in a drop-down menu 132 available from the Interviews screen 120. Among other options, a user may be able to generate and view an interview packet, download the internet packet, and email the packet.

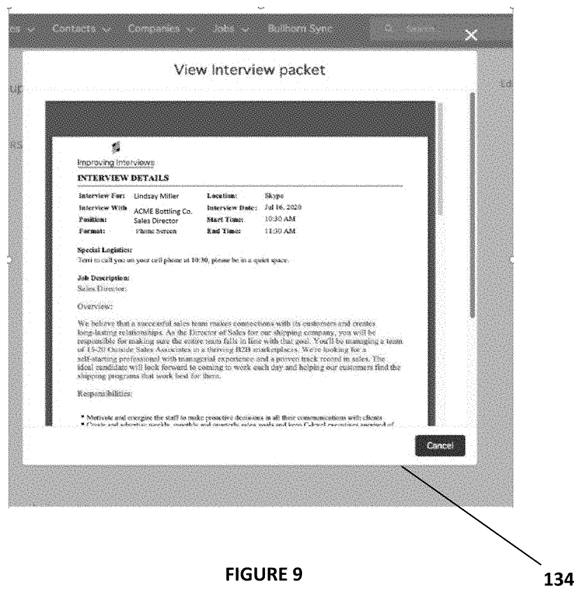

Referring to FIG. 9 an exemplary window 134 showing a portion of an interview packet is provided. This window may be provided to user upon the selection of “view an interview packet” from the drop-down menu 132. The window 134 may allow a user to preview an interview packet. The interview packet may contain a variety of information including the details of the open job position, the interview itself (location, time, format) special logistics pertaining to the interview (for example, if a phone interview who will initiate the call), the job description (overview, responsibilities, etc.) and any questions which have been tailored for the recipient based in part on the type of job, the type of interview, the interviewer or interviewee (depending on who is getting the packet). The interview packet may also include interview tips in addition to recommended questions.

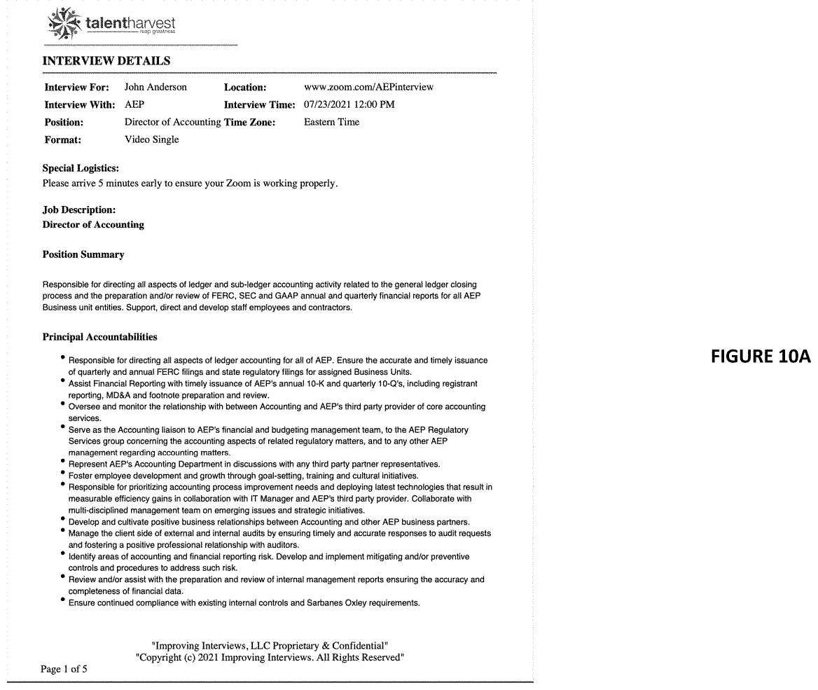

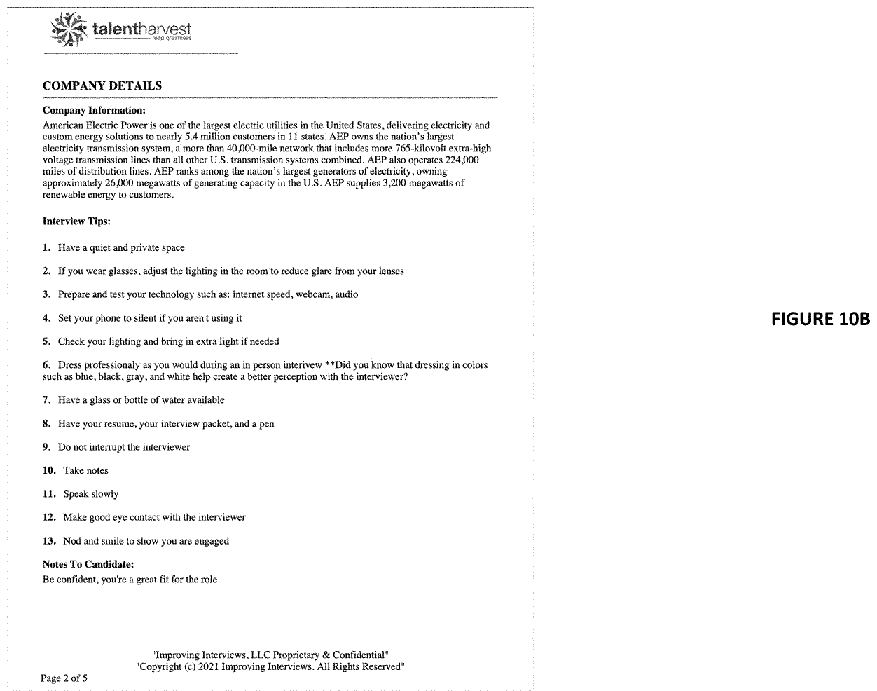

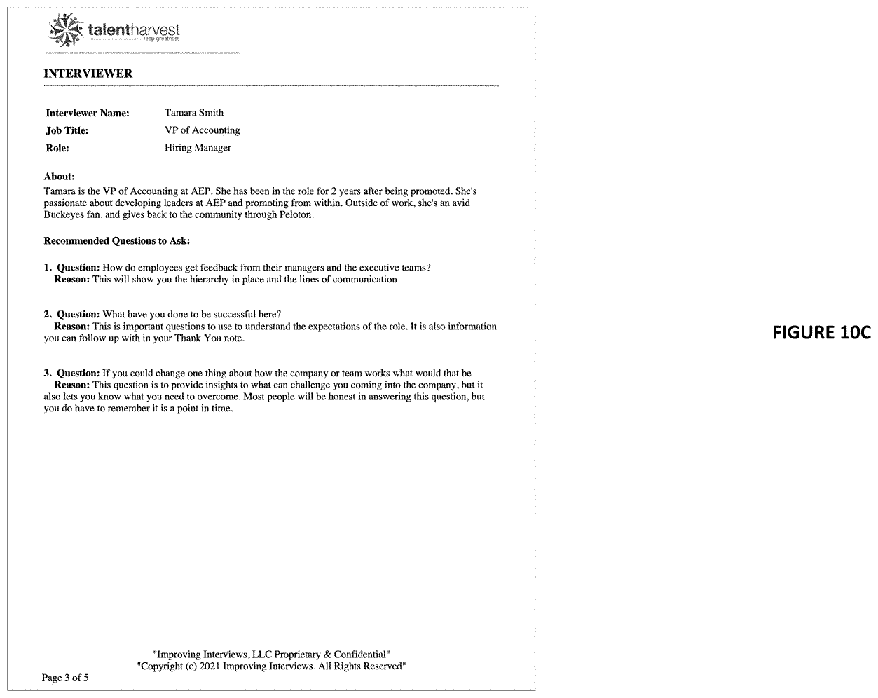

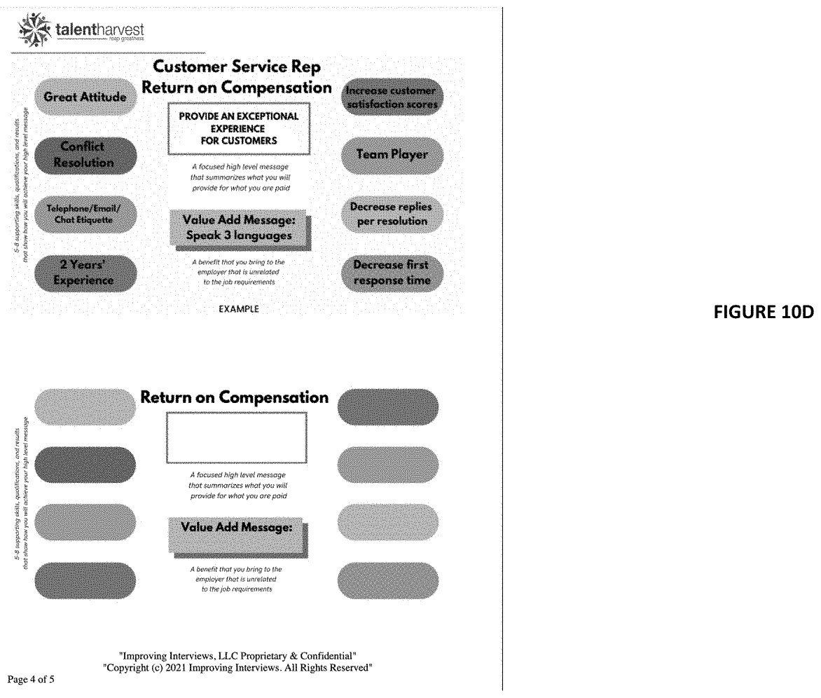

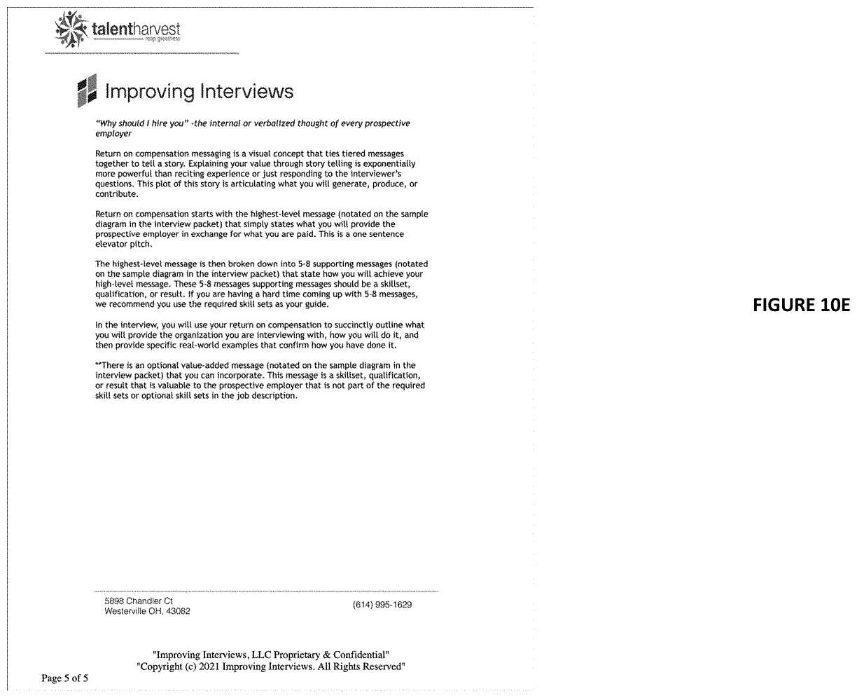

Referring to FIG. 10, an exemplary interview packet is provided. The exemplary interview packet has been generated for a job candidate (interviewee/applicant). The interview packet is generally separated into sections. The “Interview Details” section begins with general information about the interview such as the interviewee's name, who their interview is with (potential employer), position, interview format, location/type, interview date, start time, and time zone. There is a “Special Logistics” subsection where any additional instructions related to the interview may be provided. In addition, there is also a “Job Description” subsection that provides the title of the position, a position summary, and a listing of the principal accountabilities the position is responsible for. The “Interview Details” section gives the job candidate an overview of the interview logistics and the job being applied for.

A “Company Details” section sets forth basic information about the company, which can include product and industry information, as well as a listing of tips that may help the job candidate present him- or her-self in a professional and engaging manner. A “Notes To Candidate” subsection may also be provided to offer encouragement.

A “Interviewer” section provides information about the anticipated interviewer, including their name, job title, and role. If desired, other information may also be included such as the interviewer's contact information and/or information about who the interviewer reports to. An “About” subsection gives some general information about the interviewer, such as the length of time the interviewer has been with the company and some of the interviewer's personal interests (which may help the job candidate relate). Further, there is also a “Recommended Questions” subsection that provides a number of suggested questions (in this case, three) that the job candidate may ask the interviewer. Associated with each suggested question is a reason (i.e., explanation) provided below that explains why the suggested questions should be asked. It is contemplated that the Recommended Questions subsection may help facilitate dialogue between the job candidate and the interviewer.

As shown in FIG. 10D, the interview packet may also provide an example of, and a template for, “return on compensation messaging,” which is a visual concept that helps the job candidate express the candidate's value through story telling (rather than simply reciting qualifications or answering questions). Here, the candidate is invited to plot out the way in which the candidate can address the question “Why should I hire you?” (which, presumably, is a question that every employer asks themselves when interviewing a job candidate). As shown in FIG. 10E, the interview packet may further provide an explanation of “return on compensation messaging.”

The interview packet of FIGS. 10A-10E is just one embodiment of an interview packet generated by the system and one of ordinary skill in the art will recognize that interview packets could be organized in a variety of ways and contain various types of information without departing from the scope of the invention.

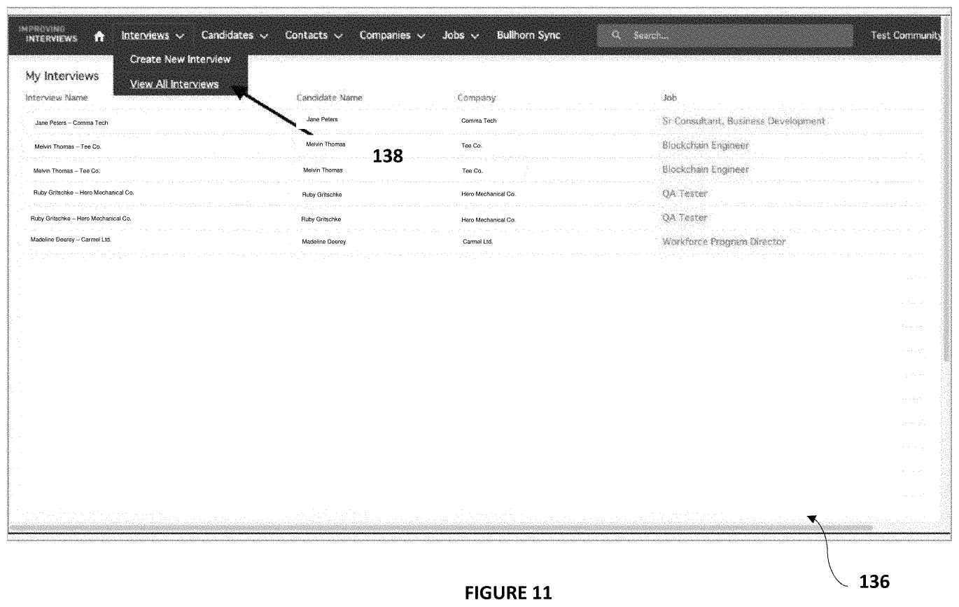

Referring to FIG. 11, a “My Interviews” screen 136 is provided. The “My Interviews” screen 136 may be accessed from a drop-down menu 138. The My Interviews screen 136 allows a user to view all the Interviews that they are associated with. For example, an Owner of multiple interview events can view a list of all upcoming interview events on the My Interviews screen 136. In various exemplary embodiments a user may be able to view both future and past interview events on the “My Interviews” screen 136. The list may display the interview name, candidate name, company name, and job title related to each interview event. All or a portion of displayed information may be associated with live links that can be clicked by a user to view further details.

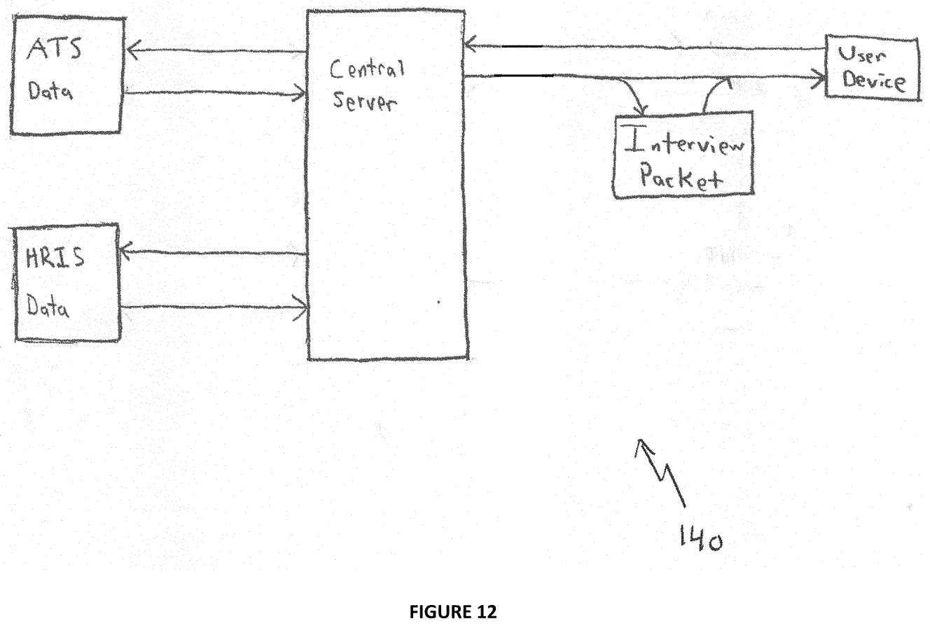

Referring to FIG. 12, a data flow diagram 140 is shown that depicts an exemplary embodiment of the system. Here, the system includes a central server connected to two remote systems—an ATS and a HRIS—that is configured to receive and transmit information to each. Further, using information collected from the ATS and the HRIS, the central sever can generate an interview packet, connect to one or more user devices (which may be a mobile phone, tablet, or PC), and transmit the interview packet to the user device(s). Control of this system is provided through an online dashboard configured to execute program instruction stored on a non-transitory computer-readable storage medium operatively connected to the central server.

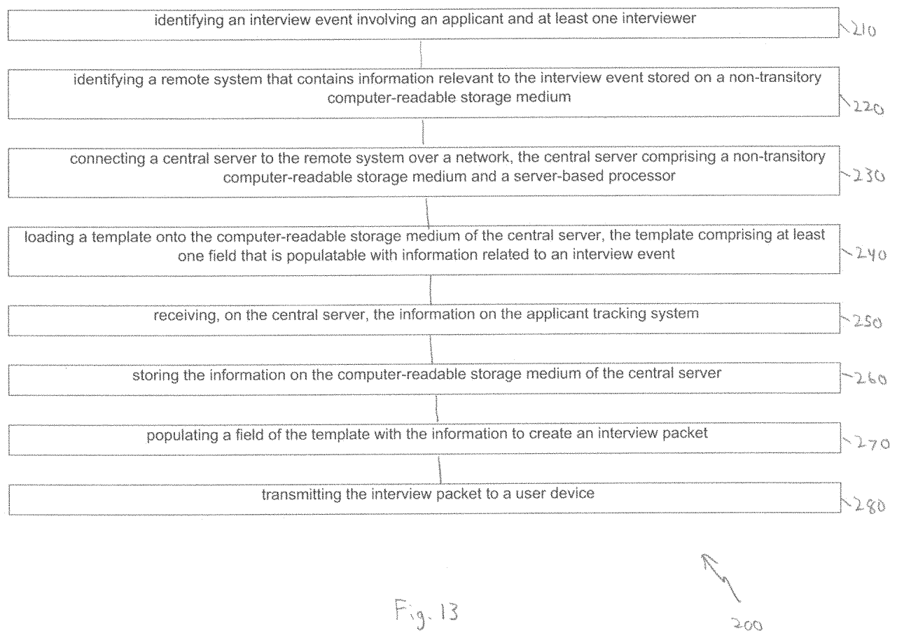

Referring to FIG. 13, a flow diagram is shown that depicts an exemplary method 200 of managing interview information. This method 200 may begin by identifying an interview event involving an applicant and at least one interviewer (block 210), and identifying a remote system that contains information relevant to the interview event that is stored on a non-transitory computer readable storage medium (block 220). From there, the method 200 includes connecting a central server to the remote system over a network, wherein the central server comprising a non-transitory computer-readable storage medium and a server-based processor (block 230). A template may be loaded onto the computer-readable storage medium of the central server that includes at least one field that is populatable with information related to an interview event (block 240). The central server may then receive information from the remote system (block 250) and store the information on the computer-readable storage medium of the central server (block 260). The information may then be used to populate a field of the template to create an interview packet (270). This interview packet may then be transmitted to a user device (280).

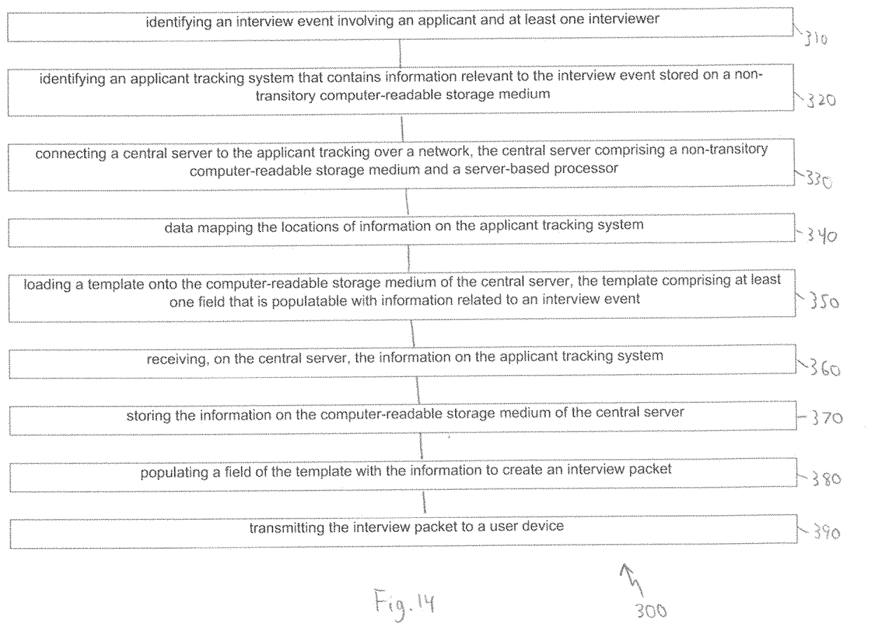

Referring to FIG. 14, a second flow diagram is shown that depicts another exemplary method 300 of managing interview information. This method 300 may begin by identifying an interview event involving an applicant and at least one interviewer (block 310) and identifying an applicant tracking system that contains information relevant to the interview event stored on a non-transitory computer-readable storage medium (block 320). From there, the method 300 includes connecting a central server to the applicant tracking over a network, wherein the central server comprising a non-transitory computer-readable storage medium and a server-based processor (block 330). Data mapping may be performed to locate relevant information on the applicant tracking system (block 340). A template may be loaded onto the computer-readable storage medium of the central server that includes at least one field that is populatable with information related to an interview event (350). The central server may then receive information from the applicant tracking system (block 360) and store the information on a computer-readable storage medium (block 370). The information may then be used to populate a field of the template to create an interview packet (380). The interview packet may then be transmitted to a user device (390).

It will be evident that there are additional embodiments and applications which are not disclosed in the detailed description, but which clearly fall within the scope of the appended claims. The specification is, therefore, intended not to be limiting. The present invention may be embodied in other specific forms without departing from its spirit or essential characteristics. The described embodiment is to be considered in all respects only as illustrative and not restrictive. All variations that come within the meaning and range of equivalency of the claims are to be embraced within their scope.

What is claimed is:

1. A method for managing interview information comprising:
identifying an interview event involving an applicant and at least one interviewer;
receiving, on a central server, information about the interview from one or more interview information sources, the central server comprising a non-transitory computer-readable storage medium and a server-based processor;
storing the information on the computer-readable storage medium of the central server;
loading a template onto the computer-readable storage medium of the central server, the template comprising at least one field that is populatable with information related to an interview event;
populating a field of the template with the information to create an interview packet; and
transmitting the interview packet to a user device.

2. The method of claim 1, wherein the interview information source is at least one of a remote system and direct user input received on a user interface.

3. The method of claim 2, wherein the remote system is at least one of an applicant tracking system and a human resource information system.

4. The method of claim 1 further comprising:
transmitting, to a user device belonging to the applicant or an interviewer, a form that comprises questions related to an interview event;
receiving the form from the user device once the questions have been responded to; and
populating a field of the template with information gathered from a response to a form question.

5. The method of claim 1, wherein:
the computer-readable storage medium of the central server has stored a pool of suggested questions for a system user; and
the method further comprises:
selecting a question from the pool of suggested questions based on the information used to populate a field of the template; and
including the selected question in the interview packet.

6. The method of claim 5, wherein:
the computer-readable storage medium of the central server has stored a pool of explanations, wherein each explanation is associated with a question from the pool of questions; and
the method further comprises:
selecting an explanation from the pool of suggest explanations based on the inclusion of a particular question in the interview packet; and
including the selected explanation in the interview packet.

7. The method of claim 1, wherein:
the computer-readable storage medium of the central server has stored a pool of interview tips for a system user; and
the method further comprises:
selecting a tip from the pool of interview tips based on the information used to populate a field of the template; and
including the selected tip in the interview packet.

8. A method for managing interview information comprising:
identifying an interview event involving an applicant and at least one interviewer;
identifying a remote system that contains information relevant to the interview event stored on a non-transitory computer-readable storage medium;
connecting a central server to the remote system over a network, the central server comprising a non-transitory computer-readable storage medium and a server-based processor;
loading a template onto the computer-readable storage medium of the central server, the template comprising at least one field that is populatable with information related to an interview event;
receiving, on the central server, the information on the remote system;
storing the information on the computer-readable storage medium of the central server;
populating a field of the template with the information to create an interview packet; and
transmitting the interview packet to a user device.

9. The method of claim 8, wherein the information comprises at least one of the identity of the applicant, the identity of an interviewer, the identity of the employer, the time of the interview, the location of the interview, the level of employment position being applied for, the format of the interview, and the number of interviewers that will be conducting the interview.

10. The method of claim 8 further comprising data mapping, on the remote system, the locations of information relevant to an interview event.

11. The method of claim 8, wherein:
the applicant tracking system further contains documents relevant to an interview event stored on the computer-readable storage medium of the applicant tracking system; and
the method further comprises:
receiving, on the central server, the at least one document from the computer-readable storage medium of the applicant tracking system;
storing the documents from the applicant tracking system on the computer-readable storage medium of the central server; and
including the documents in the interview packet.

12. The method of claim 8 wherein the documents comprise at least one of a resume, a cover letter, and a letter of recommendation associated with the applicant.

13. A system for managing interview information comprising:
a central server comprising a non-transitory computer-readable storage medium and a server-based processor;
a template stored on the computer-readable storage medium that comprises at least one field that is populatable with information related to an interview event;
program instructions stored on the non-transitory computer-readable storage medium and executable by the server-based processor that, when executed, performs operations comprising:
connecting, over a network, the central server to a remote system that has stored information relating to an interview event;
receiving, on the central server, the information on the remote system;
storing the information on the computer-readable storage medium of the central server;
populating a field of the template with the information to create an interview packet; and
a user interface configured to receive user input directing the central sever to initiate the execution of the program instructions.

14. The system of claim 13, wherein the user interface is an online dashboard accessible by a user on a user device.

15. The system of claim 13, wherein the computer-readable storage medium further comprises program instructions that, when executed by the processor, direct the processor to:
receive, on the central server, documents from the remote system that are relevant to the interview event;
store the documents on the computer-readable storage medium; and
include the documents in the interview packet.

16. The system of claim 13, wherein the computer-readable storage medium further comprises:
a pool of suggested questions for a system user; and
program instructions that, when executed by the processor, direct the processor to:
select a question from the pool of suggested questions based on the information used to populate the field of the template; and
include the selected question in the interview packet.

17. The system of claim 16, wherein the computer-readable storage medium further comprises:
a pool of suggested explanations, wherein each explanation is associated with a question from the pool of questions; and
program instructions that, when executed by the processor, direct the processor to:
select an explanation from the pool of suggest explanations based on the inclusion in the interview packet of a particular question; and
include the selected explanation in the interview packet.

18. The system of claim 13, wherein the computer-readable storage medium further comprises:
a pool of interview tips for a system user; and
program instructions that, when executed by the processor, direct the processor to:
select a tip from the pool of interview tips based on the information used to populate the field of the template; and
include the selected tip in the interview packet.
